(19) United States
(12) Patent Application Publication
(10) Pub. No.: US 2025/0162317 A1
(43) Pub. Date: May 22, 2025

(54) LIQUID DISCHARGE HEAD, HEAD UNIT, AND LIQUID DISCHARGE APPARATUS

(71) Applicants: Ryuji TSUKAMOTO, Tokyo (JP); Takashi KINOKUNI, Tokyo (JP)

(72) Inventors: Ryuji TSUKAMOTO, Kanagawa (JP); Takashi KINOKUNI, Tokyo (JP)

(21) Appl. No.: 18/839,479

(22) PCT Filed: Feb. 28, 2023
(86) PCT No.: PCT/IB2023/051834

§ 371 Date: Aug. 19, 2024

(30) Foreign Application Priority Data
Mar. 2, 2022 (JP) 2022-031739

(51) Int. Cl. B41J 2/14; B41J 2/045

(52) U.S. Cl. CPC B41J 2/1429; B41J 2/04541; B41J 2/04581; B41J 2002/14306

(57) ABSTRACT

A liquid discharge head includes a nozzle plate, a liquid chamber, multiple liquid supply channel, a valve, a piezoelectric body, and circuitry. The nozzle plate has a nozzle from which a liquid is discharged. The liquid chamber communicates with the nozzle. The multiple liquid supply channels communicate with the liquid chamber and supply the liquid to the liquid chamber from different directions, respectively. The valve opens and closes the nozzle. The piezoelectric body moves the valve to open and close the nozzle. The circuitry drives the piezoelectric body to move the valve toward the nozzle to discharge the liquid from the nozzle.

### TECHNICAL FIELD

Embodiments of the present disclosure relate to a liquid discharge device, a head unit, and a liquid discharge apparatus.

### BACKGROUND ART

In the related art, there is a liquid discharge head having a configuration in which an on-off valve opens and closes a nozzle to discharge a liquid from the nozzle. For example, PTL 1 discloses a configuration in which a plunger is moved up and down by a solenoid coil to discharge ink (liquid) from an opening of the nozzle.

### CITATION LIST

### Patent Literature

[PTL 1]

US Patent Application Publication US2012/0105522A1

### SUMMARY OF INVENTION

### Technical Problem

The liquid discharge head of PTL 1 may not increase a discharge speed of the liquid from the nozzle and may not discharge the liquid with high frequency drive.

### Solution to Problem

An object of the present disclosure is to provide a liquid discharge head that discharges a liquid with high frequency drive.

According to an embodiment of the present disclosure, a liquid discharge head includes a nozzle plate, a liquid chamber, multiple liquid supply channel, a valve, a piezoelectric body, and circuitry. The nozzle plate has a nozzle from which a liquid is discharged. The liquid chamber communicates with the nozzle. The multiple liquid supply channels communicate with the liquid chamber and supply the liquid to the liquid chamber from different directions, respectively. The valve opens and closes the nozzle. The piezoelectric body moves the valve to open and close the nozzle. The circuitry drives the piezoelectric body to move the valve toward the nozzle to discharge the liquid from the nozzle.

According to another embodiment of the present disclosure, a liquid discharge head includes a nozzle plate, a liquid chamber, multiple liquid supply channel, a valve, a piezoelectric body, and circuitry. The nozzle plate has a nozzle from which a liquid is discharged. The liquid chamber communicates with the nozzle. The valve opens and closes the nozzle. The piezoelectric body moves the valve to open and close the nozzle. The circuitry drives the piezoelectric body to move the valve to a retracted position at which the valve is retracted from the nozzle to open the nozzle, moves the valve to a sealed position at which the valve contacts the nozzle plate to close the nozzle, and move the valve to a half position between the retracted position and the sealed position. The valve does not close the nozzle at the half position.

### Advantageous Effects of Invention

As a result, according to the present disclosure, the liquid discharge head that discharges the liquid with high frequency drive can be provided.

### BRIEF DESCRIPTION OF DRAWINGS

A more complete appreciation of the embodiments and many of the attendant advantages and features thereof can be readily obtained and understood from the following detailed description with reference to the accompanying drawings

FIG. 1 is a perspective view of a liquid discharge apparatus according to an embodiment of the present disclosure.

FIGS. 2A and 2B are cross-sectional views of a liquid discharge head of the liquid discharge apparatus according to the present embodiment.

FIG. 3 is a cross-sectional view of a head unit including the liquid discharge head in which a needle valve closes a nozzle.

FIG. 4 is a cross-sectional view of the head unit including the liquid discharge head in which the needle valve opens the nozzle.

FIG. 5 is a cross-sectional view of the head unit including the liquid discharge head in which the needle valve closes the nozzle to discharge ink from the nozzle.

FIG. 6 is a cross-sectional view of the head unit including the liquid discharge head in which the needle valve approaches the nozzle.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

Embodiments of the present disclosure are described below with reference to the drawings. In the following description, a description is given of a liquid discharge head that discharges ink as an example of liquid according to an embodiment of the present disclosure.

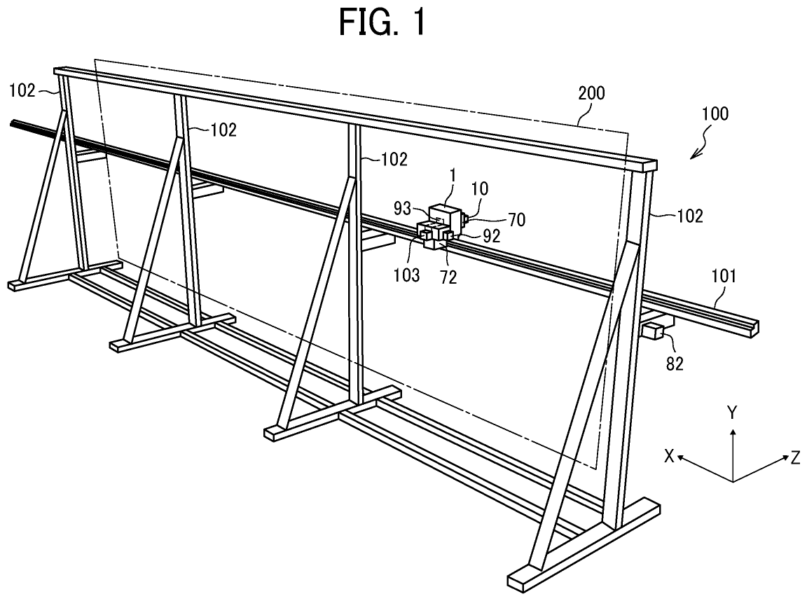

As illustrated in FIG. 1, a liquid discharge apparatus 100 is installed so as to face an object 200 on which images are drawn. The liquid discharge apparatus 100 includes an X-axis rail 101, a Y-axis rail 102 intersecting the X-axis rail 101, and a Z-axis rail 103 intersecting the X-axis rail 101 and the Y-axis rail 102.

The Y-axis rail 102 movably holds the X-axis rail 101 in the Y direction. The X-axis rail 101 movably holds the Z-axis rail 103 in the X direction. The Z-axis rail 103 movably holds a carriage 1 in the Z direction. The carriage 1 includes a liquid discharge head 10. The carriage 1 is an example of a head unit including a liquid discharge head.

Further, the liquid discharge apparatus 100 includes a first Z-direction driver 92 and an X-direction driver 72. The first Z-direction driver 92 moves the carriage 1 in the Z direction along the Z-axis rail 103. The X-direction driver 72 moves the Z-axis rail 103 in the X direction along the X-axis rail 101. The liquid discharge apparatus 100 further includes a Y-direction driver 82 that moves the X-axis rail 101 in the Y direction along the Y-axis rail 102. Further, the liquid discharge apparatus 100 includes a second Z-direction driver 93 that moves a head holder 70 relative to the carriage 1 in the Z direction.

The carriage 1 includes the head holder 70. The head holder 70 is an example of a holding body. The carriage 1 is movable in the Z direction along the Z-axis rail 103 by driving force of the first Z-direction driver 92 illustrated in FIG. 1. Further, the head holder 70 is movable relative to the carriage 1 in the Z direction by driving force of the second Z-direction driver 93 illustrated in FIG. 1.

The liquid discharge apparatus 100 described above discharges ink from the liquid discharge head 10 while moving the carriage 1 along the X-axis, the Y-axis, and the-Z axis, thereby drawing images on the object 200. The ink is an example of liquid. The movement of the carriage 1 and the head holder 70 in the Z direction may not be parallel to the Z direction, and may be an oblique movement including at least a Z direction component.

Although the object 200 is flat in FIG. 1, the object 200 may have a surface shape which is nearly vertical or a curved surface with the large radius of curvature, such as a body of a car, a truck, or an aircraft.

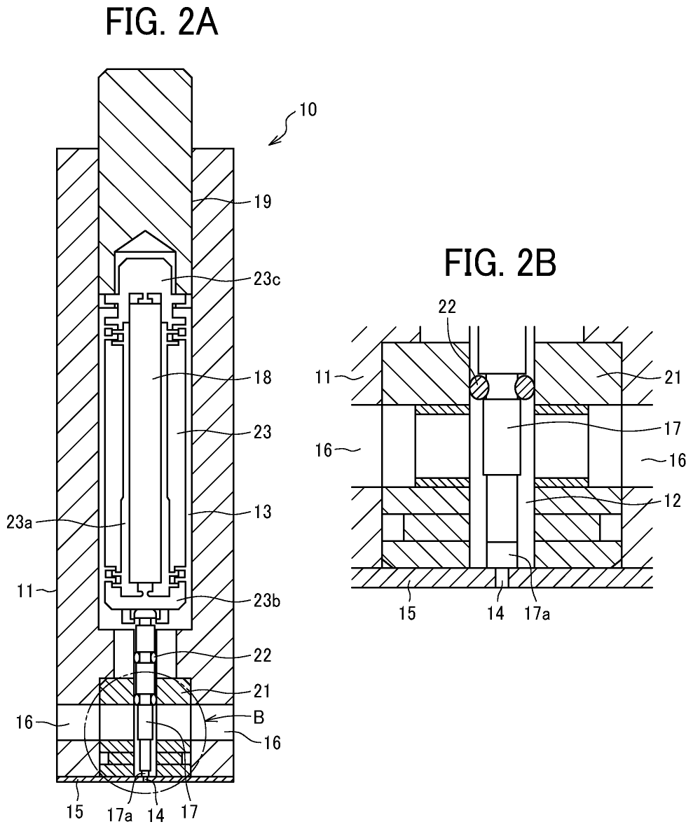

FIGS. 2A and 2B are schematic views of the liquid discharge head 10. FIG. 2A is an overall cross-sectional view of the liquid discharge head 10, and FIG. 2B is an enlarged view of a portion B in FIG. 2A.

The liquid discharge head 10 includes a housing 11. The housing 11 is made of metal or resin.

The liquid discharge head 10 includes a nozzle plate 15. The nozzle plate 15 is joined to the housing 11. The nozzle plate 15 includes a nozzle 14 from which ink is discharged.

The liquid discharge head 10 includes a needle valve 17 and a piezoelectric element 18 in the housing 11. The needle valve 17 opens and closes the nozzle 14, and the piezoelectric element 18 drives (moves) the needle valve 17. A bearing portion 21 is disposed between the needle valve 17 and the housing 11. A seal 22 such as an O-ring is disposed between the bearing portion 21 and the needle valve 17. The liquid discharge head 10 further includes a head controller 800 as circuitry to drive the piezoelectric element 18.

A piezoelectric element 18 is accommodated in a space 13 inside the housing 11. A holder 23 holds the piezoelectric element 18 in a central space 23a. The piezoelectric element 18 and the needle valve 17 are coaxially coupled to each other via a front end 23b of the holder 23. The holder 23 is coupled to the needle valve 17 on the front end 23b side and is fixed by a restraint 19 attached to the housing 11 on a rear end 23c side.

The needle valve 17 includes an elastic member 17a at a leading end thereof. When the leading end of the needle valve 17 is pressed against the nozzle plate 15, the elastic member 17a is compressed. As a result, the needle valve 17 reliably closes the nozzle 14.

In a space inside the housing 11, a portion of the space defined by the seal 22, in which the elastic member 17a of the needle valve 17 is disposed, is an ink chamber 12 as a liquid chamber to supply ink to the nozzle 14.

The housing 11 includes a supply channel 16. The supply channel 16 is a path through which ink is supplied from an ink supply bottle, which is described later, to the ink chamber 12.

The housing 11 includes the restraint 19 at a position facing an upper end of the piezoelectric element 18 in FIG. 2A. The restraint 19 is in contact with the upper end of the piezoelectric element 18 to define a fixing point of the piezoelectric element 18.

The nozzle plate 15 is an example of a discharge port forming component, the needle valve 17 is an example of an opening and closing valve (also simply referred to as a valve), and the piezoelectric element 18 is an example of a piezoelectric body.

A description is given below of a head unit 2 according to the present embodiment including the liquid discharge head 10 and a process of discharging ink from the liquid discharge head 10.

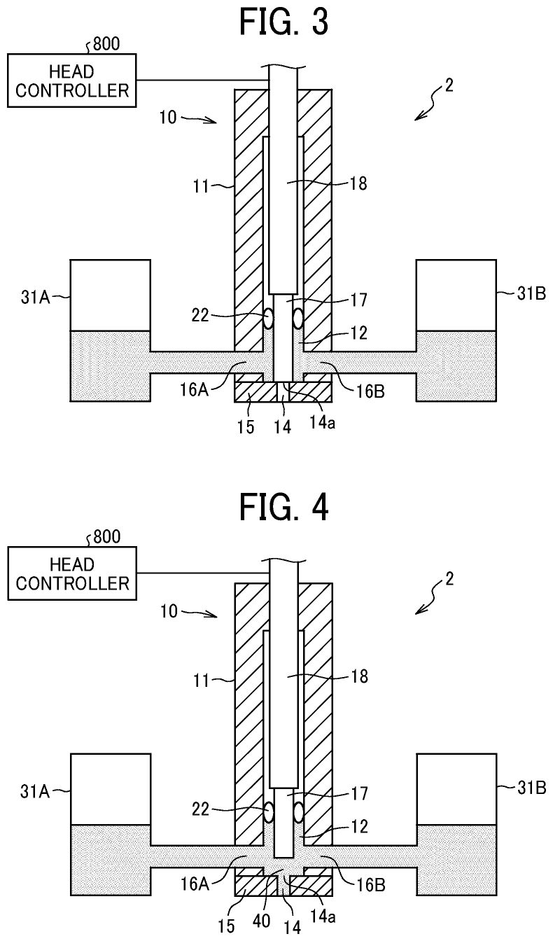

As illustrated in FIG. 3, the head unit 2 includes the liquid discharge head 10, and further includes a first ink supply bottle 31A and a second ink supply bottle 31B as liquid suppliers.

A first supply channel 16A and a second supply channel 16B as liquid supply channels are connected to the ink chamber 12 from two different directions to supply ink to the ink chamber from the two different directions. The first ink supply bottle 31A and the second ink supply bottle 31B are connected to the first supply channel 16A and the second supply channel 16B, respectively. The first ink supply bottle 31A and the second ink supply bottle 31B supply ink to the ink chamber 12. Thus, the ink chamber 12 is filled with the ink. Alternatively, ink may be supplied to the ink chamber 12 from three or more different directions.

In FIG. 3, the needle valve 17 contacts the nozzle plate 15 to seal (close) an opening 14a at the end of the nozzle 14 facing the needle valve 17.

In the present embodiment, ink in the ink chamber 12 is not pressurized even during an ink discharge operation which is described later. However, during the ink discharge operation, the ink in the ink chamber 12 may be pressurized by a pressurizing mechanism without affecting the ink discharge operation.

At the time of the ink discharge operation, a voltage is applied to the piezoelectric element 18 to cause the piezoelectric element 18 to contract. As a result, as illustrated in FIG. 4, the needle valve 17 is retracted from the nozzle 14 to open the opening 14a at the end of the nozzle 14. That is, the controller 800 drives the piezoelectric element 18 to move the needle valve 17 to a retracted position to open the nozzle 14. As a result, a pressure of ink around the opening 14a decreases, and ink is supplied to the nozzle 14 and a gap region 40 between the nozzle 14 and the needle valve 17.

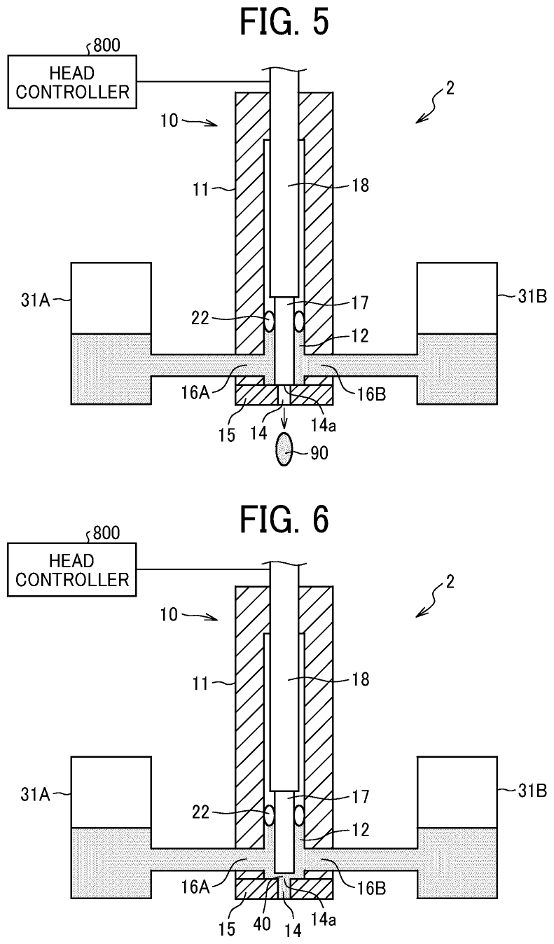

From this state, the head controller 800 drives the piezoelectric element 18 to cause the needle valve 17 to approach the nozzle 14 again, and as illustrated in FIG. 5, to move the needle valve 17 to a position to seal (close) the nozzle 14 (i.e., a sealed position). Accordingly, the ink in the gap region 40 and the nozzle 14 is pushed by the needle valve 17, and ink 90 is discharged from the nozzle 14. That is, the head controller 800 drives the piezoelectric element 18 to move the needle valve 17 toward the nozzle 14 to discharge the ink 90.

In the above-described ink discharge operation, according to the present embodiment, since ink is supplied toward the ink chamber 12 from multiple directions, a supply speed of the ink to the ink chamber 12 and the discharge speed of the ink by the liquid discharge head 10 can be increased. Accordingly, in the ink discharge operation, although the ink in the ink chamber 12 is not pressurized, the ink can be discharged with high frequency drive by an opening and closing operation of the needle valve 17.

In addition, the piezoelectric element 18 can respond to the application of the voltage at a high speed, thereby increasing the discharge speed of the ink by the liquid discharge head 10.

A description is given below of the liquid discharge head 10 (the head unit 2) according to another embodiment of the present disclosure, which is different from the above-described embodiment and performs a different ink discharge operation.

In the present embodiment, similarly to the above-described embodiment, the needle valve 17 moves from a position to seal the nozzle 14 as illustrated in FIG. 3 (i.e., the sealed position) in the direction to retract from the nozzle 14 as illustrated in FIG. 4 (i.e., the retracted position). That is, the head controller 800 drives the piezoelectric element 18 to move the needle valve 17 from the sealed position to the retracted position. Thus, the ink is supplied to the gap region 40 between the nozzle 14 and the needle valve 17.

Thereafter, the needle valve 17 approaches the nozzle 14, and moves to a position where the needle valve 17 does not seal the nozzle 14 as illustrated in FIG. 6 (i.e., a half position). That is, the head controller 800 drives the piezoelectric element 18 to move the needle valve 17 to the half position between the retracted position and the sealed position. Then, the needle valve 17 moves again in the direction to retract from the nozzle 14, for example, to the same position as illustrated in FIG. 4. That is, the head controller 800 drives the piezoelectric element 18 to move the needle valve 17 to the retracted position again. Lastly, the needle valve 17 approaches the nozzle 14 again, and seals (closes) the nozzle 14 as illustrated in FIG. 5. That is, the head controller 800 drives the piezoelectric element 18 to move the needle valve 17 to the sealed position. As a result, the ink is discharged from the nozzle 14 similarly to the above-described embodiment.

As described above, in the present embodiment, the needle valve 17 reciprocally moves twice in the opening and closing direction in the order of positions illustrated in FIG. 3, FIG. 4, FIG. 6, FIG. 4, and FIG. 5. In other words, the head controller 800 drives the piezoelectric element 18 to move the needle valve 17 from the sealed position to the retracted position, reciprocally move the needle valve 17 from the retracted position to the half position, and move the needle valve 17 to the sealed position. As the needle valve 17 moves from the retracted position illustrated in FIG. 4 to a position where the nozzle 14 is not sealed as illustrated in FIG. 6 (i.e., the half position), bubbles in the nozzle 14 or in the vicinity thereof can be pushed out to the outside. In addition, reciprocal movement of the needle valve 17 increases the supply speed of the ink to the ink chamber 12 and the discharge speed of the ink by the liquid discharge head 10. Thereafter, the needle valve 17 opens and closes the nozzle 14 to discharge the ink from the nozzle 14 again. As a result, the volume of an ink droplet to be discharged from the nozzle 14 can be increased. The positions of the needle valve 17 when the needle valve 17 open the nozzle 14 in the two reciprocal movements are not necessarily the same. Although the description is given of the present embodiment with reference to FIGS. 3 to 5 which are the same as those of the above-described embodiment for the sake of convenience, the mechanism and operation of both embodiments are not necessarily the same. For example, the amount of movement of the needle valve 17 is not necessarily the same, and the amount of the ink 90 discharged as illustrated in FIG. 5 is not necessarily the same in the two embodiments.

Further, the number of times of reciprocal movement of the needle valve 17 may be three or more, and in the present embodiment, the head controller 800 can change the number of times of reciprocal movement of the needle valve 17. As the number of times of reciprocal movement of the needle valve 17 is increased, the volume of ink discharged from the nozzle 14 can be increased. In other words, a desired volume of ink can be discharged from the nozzle 14 by changing the number of times of reciprocally moving the needle valve 17.

In another embodiment described above, the liquid discharge head 10 may include only one liquid supply channel to supply ink to the ink chamber 12.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

The term “liquid” includes not only ink but also paint.

In the present disclosure, the term “liquid discharge apparatus” includes a liquid discharge head or a head unit and drives the liquid discharge head to discharge liquid. The term “liquid discharge apparatus” used here includes, in addition to apparatuses to discharge liquid to materials onto which liquid can adhere, apparatuses to discharge the liquid into gas (air) or liquid.

The “liquid discharge apparatus” may further include devices relating to feeding, conveying, and ejecting of the material onto which liquid can adhere and also include a pretreatment device and an aftertreatment device.

The “liquid discharge apparatus” may be, for example, an image forming apparatus to form an image on a sheet by discharging ink, or a three-dimensional apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms meaningless images such as meaningless patterns or an apparatus that fabricates three-dimensional images.

The above-described term “material onto which liquid can adhere” serves as the object described above and represents a material on which liquid is at least temporarily adhered, a material on which liquid is adhered and fixed, or a material into which liquid is adhered to permeate. Specific examples of the “material onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “material onto which liquid can adhere” includes any material to which liquid adheres, unless particularly limited.

Examples of the “material onto which liquid can adhere” include any materials to which liquid can adhere even temporarily, such as paper, thread, fiber, fabric, leather, metal, plastic, glass, wood, and ceramic.

The term “liquid discharge apparatus” may be an apparatus to relatively move the liquid discharge head and the material onto which liquid can adhere. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a paper sheet to apply the treatment liquid to the surface of the paper sheet, for reforming the surface of the paper sheet; and an injection granulation apparatus that injects a composition liquid, in which a raw material is dispersed in a solution, through a nozzle to granulate fine particle of the raw material.

The terms “image formation,” “recording,” “printing,” “image printing,” and “fabricating” used in the present disclosure may be used synonymously with each other.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application No. 2022-031739, filed on Mar. 2, 2022, in the Japan Patent Office, the entire disclosure of which is hereby incorporated by reference herein.

### REFERENCE SIGNS LIST

2 Head unit
10 Liquid discharge head
12 Ink chamber (liquid chamber)
14 Nozzle
15 Nozzle plate (discharge port forming component)
16A First supply channel (liquid supply channel)
16B Second supply channel (liquid supply channel)
17 Needle valve (valve)
18 Piezoelectric element (piezoelectric body)
31A First ink supply bottle (liquid supplier)
31B Second ink supply bottle (liquid supplier)
40 Gap region
100 Liquid discharge apparatus

1. A liquid discharge head, comprising:
a nozzle plate having a nozzle from which a liquid is discharged;
a liquid chamber communicating with the nozzle;
multiple liquid supply channels communicating with the liquid chamber, the multiple liquid supply channels to supply the liquid to the liquid chamber from different directions, respectively;
a valve to open and close the nozzle;
a piezoelectric body to move the valve to open and close the nozzle; and
circuitry configured to drive the piezoelectric body to move the valve toward the nozzle to discharge the liquid from the nozzle.

2. The liquid discharge head according to claim 1,
wherein the circuitry is further configured to drive the piezoelectric body to:
move the valve to a retracted position at which the valve is retracted from the nozzle to open the nozzle;
move the valve to a sealed position at which the valve contacts the nozzle plate to close the nozzle; and
move the valve to a half position between the retracted position and the sealed position,
wherein the valve does not close the nozzle at the half position.

3. The liquid discharge head according to claim 2, wherein the circuitry is further configured to drive the piezoelectric body to:
move the valve to the retracted position;
reciprocally move the valve from the retracted position to the half position; and
move the valve from the retracted position to the sealed position to discharge the liquid from the nozzle.

4. The liquid discharge head according to claim 3, wherein the circuitry is further configured to:
change a number of times of reciprocal movement of the valve from the retracted position to the half position.

5. A head unit comprising:
the liquid discharge head according to claim 1; and
a carriage mounting the liquid discharge head and to move the liquid discharge head.

6. A liquid discharge apparatus comprising:
the head unit according to claim 5; and
a driver to move the carriage.

7. A liquid discharge head comprising:
a nozzle plate having a nozzle from which a liquid is discharged;
a liquid chamber communicating with the nozzle;
a valve to open and close the nozzle;
a piezoelectric body to move the valve to open and close the nozzle; and
circuitry configured to drive the piezoelectric body to:
move the valve to a retracted position at which the valve is retracted from the nozzle to open the nozzle;
move the valve to a sealed position at which the valve contacts the nozzle plate to close the nozzle; and
move the valve to a half position between the retracted position and the sealed position,
wherein the valve does not close the nozzle at the half position.

8. The liquid discharge head according to claim 7, wherein the circuitry is further configured to drive the piezoelectric body to:
move the valve to the retracted position;
reciprocally move the valve from the retracted position to the half position; and
move the valve from the retracted position to the sealed position to discharge the liquid from the nozzle.

9. The liquid discharge head according to claim 8,
wherein the circuitry is further configured to change a number of times of reciprocal movement of the valve from the retracted position to the half position.
